(19) United States
(12) Patent Application Publication
(10) Pub. No.: US 2003/0123456 A1
(43) Pub. Date: Jul. 3, 2003

(54) Methods and system for data packet filtering using tree-like hierarchy

(76) Inventors: Peter R. Denz, Cary, NC (US); Vishnu Natchu, San Jose, CA (US); Steven L. Blake, Cary, NC (US)

Correspondence Address: Arthur I. Navarro, Godwin Gruber, P.C., Suite 655, 801 E. Campbell Rd., Richardson, TX, 75081, US

(21) Appl. No.: 10/028,473

(22) Filed: Dec. 28, 2001

(51) Int. Cl. H04L 12/28; H04L 12/56

(52) U.S. Cl. 370/400; 370/392

(57) ABSTRACT

A method of filtering an incoming data packet stream in a data packet transmission system. The method comprises a step of defining a tree-like hierarchy for a plurality of filter conditions such that the filter conditions are divided into groups of filters, each of the groups associated with one or more fields having pre-determined condition values. The groups are arranged in long edges of the tree-like hierarchy. Next, a data packet stream is received at a point of ingress to the data packet transmission system and condition values along the edges of the tree-like hierarchy are compared to specified portions of the data packet stream to determine where there are matches. If matches are made along an entire edge of the tree-like hierarchy, the data packet stream is filtered according to the number of condition values compared as opposed to the number of filters.

### TECHNICAL FIELD

The invention pertains to packet filtering. More specifically, the invention relates to a method of data packet filtering that utilizes a decision graph having a tree-like structure to allow fast and efficient packet filtering.

### BACKGROUND OF THE INVENTION

Internet protocol (IP) networks have been deployed at an increasing rate as a transport mechanism for a large number of data networking applications. IP packet filtering is a process of checking each IP packet that is going to be sent from one computer to another computer in an IP network. Essentially, a network consists of nodes, and links coupling the nodes to each other, with suitable data switching, routing, reception and transmission equipment at the nodes. IP packet filtering is widely used in internet firewall systems by independent service providers and organizations connected to the network.

Filter rules are most commonly employed to allow implementation of differentiated services based on the data type. One problem that must be overcome for a differentiated services implementation is packet classification. That is, for a given incoming packet, a selection as to which of several service schemes are to be applied to the packet must be made by selecting one filter among many which the packet may match. For packet classification, a classification key composed of packet fields located at pre-specified offsets within the packet is typically used as a packet filter. A packet filter may specify conditions for many items in the packet stream such as the IP, TCP, UDP, or ICMP headers, including the IP source address (IPSA), IP destination address (IPDA), Differentiated Services Code Point (DSCP), IP protocol field, source port, destination port, and IP precedence field. Each of the subfields of the IP filters are specified by giving a value and a mask length, specified in the number of bits from the most significant bit to be considered and the value it must have for this filter to match.

It is important and necessary to have efficient filtering algorithms which can determine quickly which of the filter conditions match the current arriving packet. Speed is of the upmost importance as the decision must be made for every packet that arrives at the equipment interface. Typically, the equipment comprises a router with an interface to one or more data links of a data network. The router bears the primary responsibility for inspecting the incoming data packet and applying filtering algorithm that enables differentiated services. At the same time, there are many other uses of a filtering algorithm such as, for example, determining which packets belong to certain tunnels in the IP architecture, access filtering, policy based routing, and accounting filters. In addition, there are non-networking applications which may utilize packet filtering algorithms for solving a wide variety of regular expression matching problems.

Thus a need exists for an improved method of filtering incoming data packets. An efficient and fast way of filtering IP packets for packet classification allowing the implementation of differentiated services would provide numerous advantages.

### SUMMARY OF THE INVENTION

The present invention provides a filtering mechanism that can be applied to an incoming data packet stream to achieve fast and efficient packet filtering and thereby enable the implementation of differentiated services and other expression matching applications. The invention utilizes a decision graph having a tree-like hierarchy to narrow down a set of matching filters at each stage of the graph. With the present invention, the number of comparisons needed to determine the subset of matching filters which match an incoming data packet stream is equal to the number of bytes in the search and not the number of filters. This provides a filtering solution that is scalable and efficient in terms of decision processing time.

Therefore, according to one embodiment, disclosed is a method of filtering an incoming data packet in a data packet transmission system. The method comprises a step of creating a decision tree having a tree-like hierarchy organized into edges and stages having test conditions which define filters. The filters are arranged along edges and stages of the tree-like hierarchy according to common values. When a data packet is received at a point of ingress to the data packet transmission system, condition values along the edges of the tree-like hierarchy are compared to specified portions of the data packet to determine where there are matches. If matches are made along an entire edge of the tree-like hierarchy, the data packet is filtered according to the number of comparisons made and not the number of filters.

Also disclosed is a method of filtering incoming packets at the interface of a router to provide differentiated services when the router receives incoming packets from a data network. The method comprises the step of constructing a data structure that stores a set of filters in a tree-like hierarchy. The tree-like hierarchy has edges organized in two stages with the set of filters subdivided according to their values along the edges and stages. Next, the interface of the router receives an incoming data packet and compares segments of the incoming data packet to values of the filters stored in the tree-like hierarchy. The comparison is done such that data packets can be differentiated by comparing specific packet fields to the set of filters which have been organized according to common values along the tree-like hierarchy meaning segments are compared along stages, and not every edge of the tree-like hierarchy, thereby allowing the incoming data packet to be differentiated according to matches between segments compared and specificfilter values. The comparison step can be done by executing a single instruction that filters incoming data packets according to their contents. Also, the comparison step can be done on a byte-by-byte basis with an offset from the beginning of the incoming data packet to increase the speed of filtering. Once a match is made at one byte, a second byte of the data packet is compared at a lower stage of the tree-like hierarchy, thereby eliminating the need to perform a comparison against all possible sets of filter conditions.

Also disclosed is a router for use in a data network that allows the implementation of differentiated services by efficient filtering of incoming data packets. The router comprises an interface to the data network and a packet processing unit coupled to the interface and adapted for receiving incoming data packets via the interface from the data network. The packet processing unit may comprise an application specific integrated circuit (ASIC) designed for filtering purposes according to the kind of services and level of differentiation required by the system. The router further includes memory means operably coupled to the packet processing unit and adapted for storing software instructions that cause the packet processing unit to filter incoming data packets. A data structure is provided and adapted for storing a set of filters in a tree-like hierarchy, the tree-like hierarchy including edges and stages, with the set of filters subdivided according to their values along the edges and stages of the tree-like hierarchy. The software instructions in the memory space are adapted to cause the packet processing unit to compare segments of incoming data packets to values of the filters stored in the tree-like hierarchy, such that the segments are compared along stages and not every edge of the tree-like hierarchy. This allows the incoming data packet to be differentiated according to matches between segments compared and specific values as opposed to all possible filters.

The present invention offers numerous advantages over conventional ways of packet filtering. With the present invention, the filtering algorithm is scalable and the number of instructions executed to filter a packet does not increase as the number of filters grows. Moreover, the methodology of the present invention can be implemented in an algorithm that uses a single software instruction with parameters that greatly aid in the speed and efficiency of the filtering function.

### BRIEF DESCRIPTION OF THE DRAWINGS

The above, and other advantages, will be understood by reference to the following detailed description in connection with the appended drawings in which:

FIG. 1 is a process flow diagram for the method of the present invention of filtering incoming data packets;

FIG. 2 illustrates the use of filter sets and their organization along a tree-like hierarchy;

FIG. 3 illustrates the tree-like hierarchy and having filter sets with wildcards;

FIG. 4 illustrates the variables that can be used with a single instruction for packet filtering;

FIG. 5 is a process flow diagram for the method of grouping filters into sets and byte subdivision according to the present invention;

FIG. 6 is an example illustration of the use of a single instruction to perform packet filtering according to the present invention; and

FIG. 7 is a generalized block diagram of a router adapted for performing the packet filtering method of the present invention.

Corresponding numerals and references in the figures correspond to like references in the detailed description unless otherwise indicated.

### DETAILED DESCRIPTION OF THE PREFERRED EMBODIMENTS

The present invention provides methods and a related system for filtering an incoming data packet using a data structure that has a tree-like hierarchy. With the present invention, filters are subdivided according to their common values along particular portions of the filters. Subdivision continues until all common values have been organized along the tree-like hierarchy which is used to filter incoming data packets within the data transmission system.

With reference now to the figures and in particular to FIG. 1, therein is shown a process flow diagram of the method of filtering IP packets according to one embodiment of the present invention. The method, denoted generally as 10, provides a way of defining a decision graph which can be used to narrow down a set of matching filters for efficiently filtering incoming data packets. In general, the method 10 operates by limiting the number of decisions to the number of bytes of the filter as opposed to the number of filters.

Filters consist of a series of value/mask pairs where the value represents some series of bits that are compared against sections of an incoming data packet. The mask specifies which of the bits in the value field are significant. For method 10, all masks are left contiguous in the filter field and a notation can be used to designate the value/mask pair. For instance, if a match is desired for any incoming source address (IPSA) which is four bytes in length with the first two bytes given in its dotted decimal form (such as 192.168), the mask can be specified as 255.255.0.0. For simplicity, the value/mask pair designation can be written as 192.168.0.0/16, representing the fact that a match is desired with the 16 leftmost bits. Given a desired match with 192.168, a first filter can be defined as 192/8 for the first byte of the IPSA and 168/8 for the second byte. The remaining two bytes of the IPSA are wildcarded and would be designated at 0/0 since the value of these two bytes are a “don't care.” In this way, a filter is defined which can be compared and matched against specific bytes of incoming data packets.

Therefore, method 10 begins at step 20, wherein the set of all filters of interest are defined according to the type of packet classification desired. Next, at step 22, the set of filters is divided based on specified values of portions of the filters such as, for example, specific bytes of each filter. Next, at step 24, a decision is made if all filters have been visited and, if not, process flow is redirected back to step 22 wherein the filters are further subdivided according to subsequent portions of the filters, such as by locating another byte position of the filter. This process continues until all filters have been visited.

Once all filters have been visited, process flow is directed to step 26 wherein the decision graph structure has been completed. We refer to the decision graph structure as a decision tree, its use to be described in further detail below. Next, at step 28, the system waits to receive an incoming data packet. Once received, portions of the incoming data packet are compared with edges of the decision tree, step 30. Since condition comparisons are made along edges and stages of the decision tree, the number of comparisons made is equal to the number of filter bytes to the number of filters. Specifically, as explained in more detail below, the decision tree is organized into levels or “stages”, such that once a match is made at one stage, the filtering algorithm automatically drops to a second stage without further comparison at the stage above. If matches are made along an entire edge of the decision tree, the data packet is filtered and its contents have been classified according to value. Therefore, a match has been made, step 32. By filtering an incoming data packet in this way, the data system is able to efficiently classify a packet and provide fast differentiated services.

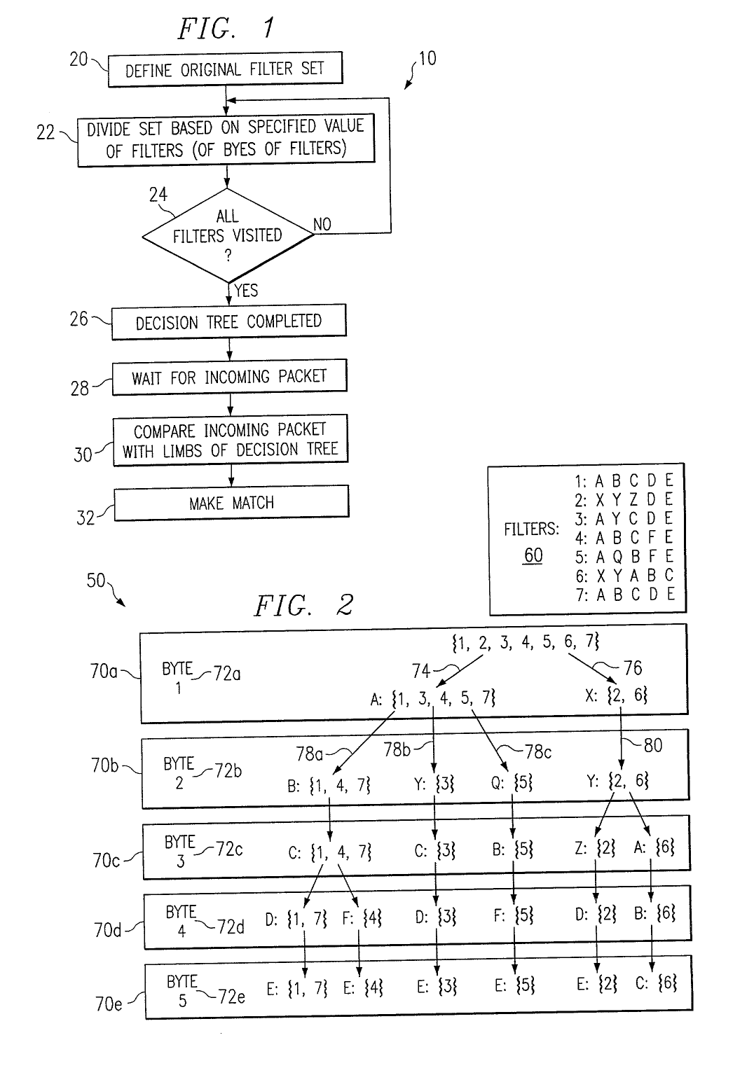

Therefore, the present invention provides a method of filtering a data packet in a data packet transmission system. With reference now to FIG. 2, therein is shown the process of the present invention utilizing a tree-like hierarchy that represents a decision tree for filtering incoming data packets. The tree-like hierarchy, denoted generally as 50, is used to divide a set of filters 60 into a plurality of stages 70a:70e starting with an uppermost stage 70a to the lowest stage 70e. Each stage corresponds to a specified byte 72a:72e of the filters 60, such that the filters are subdivided along edges of the tree-like hierarchy 50 in terms of common values. It should be understood that tree-like hierarchy 50 is representative of a decision tree in the most general sense and that specific structure for a decision tree would depend on the system and level of classification required.

As shown, filter sets 60 contain a plurality of filters (1, 2, 3, 4, 5, 6, 7) with each filter in turn having specified values at each byte (A, B, C, D, E, F, Q, X, Y, Z). Therefore, the process of subdividing the filter sets 60 to facilitate packet filtering begins by choosing a single byte, for example byte 1, which is subdivided based on its values. The resulting division, as shown in stage 70, leads to filters whose first byte contains an “A” value and a second filter whose first byte contains an “X” value. In this example, edges 74 and 76 define paths of the tree-like hierarchy 50 with common values at the same filter position.

While the example of FIG. 2 illustrates the subdivision methodology of the present invention using seven filters 60, it should be understood that more or less filters may be utilized in any particular implementation. The method of subdividing and grouping filter sets facilitates a wide array of differentiated services applications as well as an efficient and fast way of data packet filtering. Likewise, while the tree-like hierarchy 50 includes five stages 70a:70e, it should be readily understood that more or less stages may be employed in any particular packet filtering algorithm.

The process of subdividing the filter 60s continues as illustrated in FIG. 2 to create the tree-like hierarchy 50 having five stages 70a:70e corresponding to five bytes 72a:72e, such that the lowest stage 70e represents the final possible subdivision of filters having common values. Thus at the lowest stage 70e, all filters have been visited along all relevant byte positions. The tree-like hierarchy 50 represents the building of a decision tree which can be used to quickly determine which subsets of filters match a particular incoming packet. When a particular packet arrives, the algorithm of the present invention can be used to filter the data packet at the position representing byte 1 of the search key to determine whether it contains an “A” or an “X” corresponding to edges 74 and 76, respectively. If the incoming packet contains an “A” expression, matching would continue from edge 74 to edges 78a, 78b or 78c to determine if the incoming data packet at the second byte includes values “B” “Y” or “Q.”

The process continues in this way walking down all stages 70a:70e down the treelike hierarchy 50, after which it is known exactly which filters match the values of the incoming data packet. Therefore, the comparison methodology of the present invention provides an efficient and fast way of determining the subset of matching filters since the number of comparisons is equal to the number of bytes that are being compared and not the number of filters. This provides a packet filtering algorithm that is scalable in terms of decision processing time.

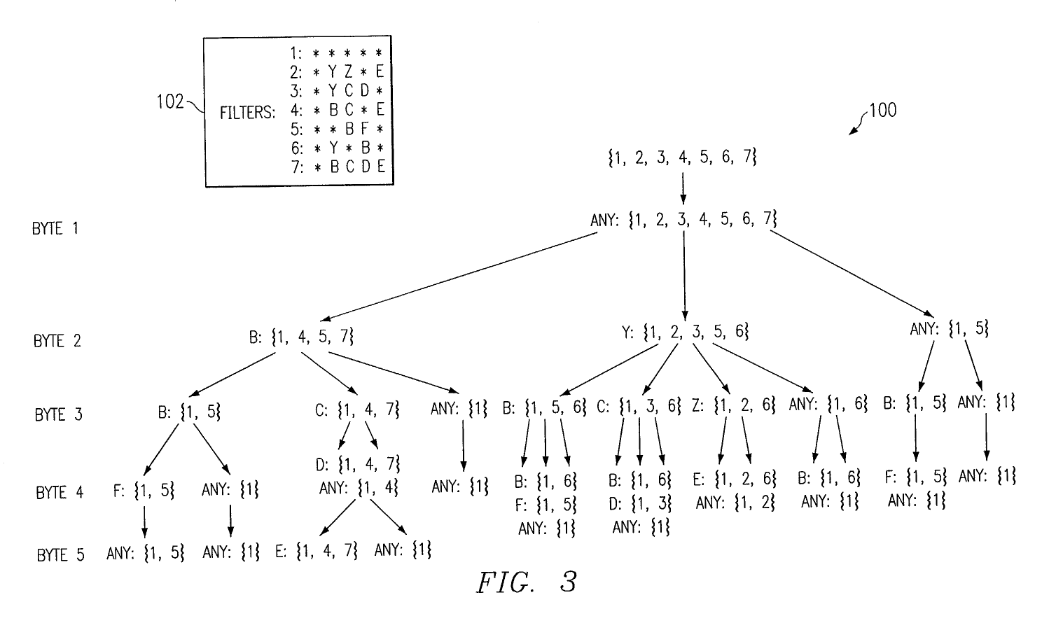

With reference now to FIG. 3, therein is shown an example tree-like hierarchy 100 which is similar to the tree-like hierarchy 50 of FIG. 2, except that it accommodates byte values with wildcards meaning that the filter is not specific to a value at one or more positions of the incoming data packet. This is shown by wildcarded filters 102 wherein the “don't care” values are shown as an asterisk. Note that filter 1 of wildcarded filters 102 has wildcard values at every position, meaning that any incoming data packet is matched by any input that matches none of the other subsets.

The tree-like hierarchy 100 is more complicated than the tree-like hierarchy 50, resulting in a more complicated decision tree including wildcarded bytes that get replicated across all subsets of a parent filter set. Compared to linear matching expression algorithms, however, the process using a tree-like structure to subdivide filters, as illustrated in FIGS. 2 and 3, provides significant efficiency advantages as well as speed in the matching algorithms and scalability.

Byte Selection Heuristic

It should be apparent to one of ordinary skill in the art that the examples of FIGS. 2 and 3 are but exemplary and that changes to the structure and form of the decision tree used to enable packet filtering can be made. For example, with the tree-like hierarchies 50, 100, the first byte was chosen to enable the comparison on an incoming data packet in a sequential order. While this simplifies the logic structure of the decision tree, it will rarely lead to an optimal tree in terms of its total tree size. It has been found, therefore, that the size of the decision tree can be reduced by dynamically choosing the next byte for comparison along any edge using a heuristic. Moreover, it has been found that a good heuristic is one where the next byte chosen contains the fewest number of wildcarded filters since the wildcarded filters are replicated in each subset in a parent filter set by choosing a byte containing the fewest number of wildcarded filters. Subsets are created from the filter set containing the smallest number of entries when summed together. Hence, the subtree tends to be smaller in size.

Therefore, the present invention provides a way of limiting the size of the tree-like structure used for a decision tree during IP packet filtering by dynamically choosing the best byte at each stage, such that different paths down the tree-like architecture, from the root to a leaf, may compare bytes in a different order.

Collapsing Subsets

Another aspect of the tree-like architectures 50, 100 is that the decision graphs are formed by successively subdividing a set of filters according to a byte in the search key. For process optimization, however, it is possible to collapse like subsets at any stage in the packet filtering algorithm. Therefore the decision graph actually may form a directed acyclic graph, as multiple edges from a parent may collapse into the same child.

Single Instruction

The packet filtering methods of the present invention include novel components in that a comparison is done at each stage of the decision tree (as represented by FIGS. 2 and 3, as examples). The algorithms, however, may be implemented in any suitable device, such as an application specific integrated circuit (ASIC) designed to perform the filtering functions. It has been found that an ASIC so designed can work in connection with a single software instruction which aids in the filtering process. An example of such an instruction is as follows:

cmpdemux(cmp_len, cmp_val demux_len, pkt_offset, table_ptr), cmp_fail_ptr

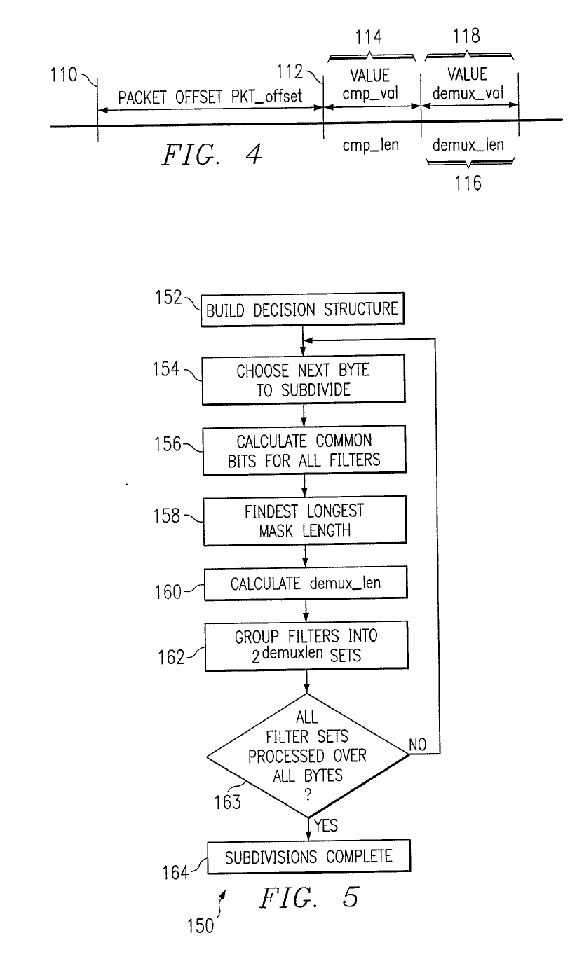

Therefore, as illustrated in FIG. 4, the cmpdemux instruction advances from the beginning of the packet's IP header field 110 the value specified in the packet offset (pkt_offset) field 112. The instruction looks at the next cmp_len bits and determines if the value of the bits in the cmp_val field 114 is cmp_val. If it is not, execution jumps to the address specified by cmp_fail ptr, meaning that the filtering algorithm has been unsuccessful. Otherwise, the comparison succeeds and the instruction looks at the value contained in the demux_len field 116 and uses this value referred to as demux_val as the index into a table of 2^{dmux}^{_{—}}^{len} instructions. The instruction pointed to by the table pointer and the demux_val 118 is executed next. The use of a single instruction with an ASIC as described above lends itself to a convenient implementation of a graph-based filtering algorithm.

Having described the methods of IP packet filtering according to the invention and its use in a system that utilizes a single instruction to perform expression matching, reference is made to FIG. 5 which is a process flow diagram for the method of building a decision tree according to the present invention. The method, denoted generally as 150, begins at step 152 wherein the decision structure of the tree-like architecture used in the decision tree is devised. Next, process flows to step 154, wherein a byte is chosen to subdivide in an effort to narrow down the filter set to only those filters that match. This is done by choosing the next byte to subdivide dynamically, and at each stage, based on the minimum wildcard heuristic. In particular, at step 156, the cmpdemux for all filters of this stage is generated and, based upon the choice of byte, a calculation as to the maximum number of leftmost bits which all of the filters have in common in the byte is made. This calculation becomes our cmp_len value referred to in FIG. 4.

Next, at step 158, the longest mask length is determined among the current filters and the variable demux_len is calculated, step 160. As discussed above, demux_len equals max_mask_len minus cmp_len. At this point, all filters can be grouped into 2^{dmux}^{_{—}}^{len} sets, step 162, such that each demux_val maps to the appropriate set of matching filters for the chosen byte.

Process flow is directed to step 163 wherein the decision is made if all filters sets have been processed over all bytes being filtered. If not, process flow is redirected back to step 154 and the algorithm recursively processes each of the remaining sets until all sets have been processed over all bytes. Once all sets have been processed over all bytes, process flow is directed to step 164, wherein all subdivisions for all filter sets have been completed.

Since wildcards are a very common occurrence within differentiated services filters, it is not necessary to include wildcards in the calculation of the cmpdemux parameters (cmp_len, demux_len, etc.). Instead, the parameters can be calculated without the wildcarded filters and the filters added to each of the subdivisions with an additional subdivision made which represents the no-match condition of the cmpdemux instruction. This is appropriate since the incoming data packet will automatically match any wildcarded filters. This special treatment of wildcards prevents all of the cmpdemux instructions from using a demux_len of 8, yielding a demux table of 256 entries.

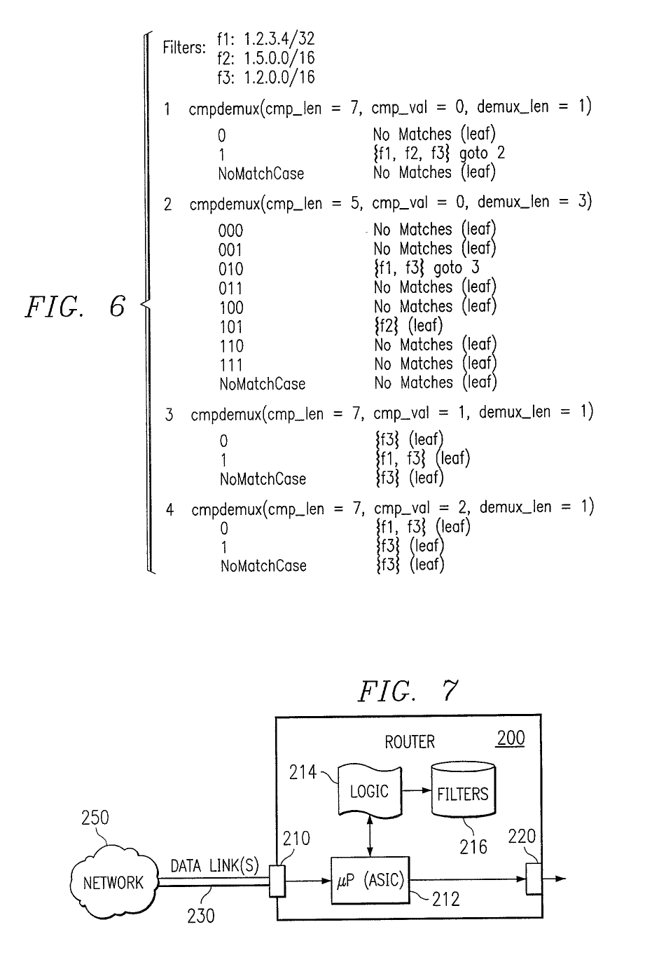

FIG. 6 illustrates the use of the cmpdemux instruction in an example using filters f1, f2, and f3 to prune an incoming data packet. The first cmpdemux instruction looks at byte 1. Since all filters contain a value 1 in this byte and a mask of (11111111)₂, then we would set the cmp_len to 8, because all of the filters contain 8 bits in common in this byte. However, since the cmpdemux instruction's demux_len must be at least 1, cmp_len is set to 7 and the demux_len to 1, leading to a table of two entries. Since all filters fall into the category of having a demux_val of 1, it is specified in table entry 1 that the pruned filter set is {f1, f2, f3} (i.e., no filters were pruned). Since no filters have a demux_val of 0, that table entry corresponds to no filter matches.

When a packet arrives, the cmpdemux instruction will look at the first cmp_len (i.e., 7) bits of the first byte of the search key and check to see if the value is cmp_val (0). If so, the instruction looks at the next demux_len (1) bits and uses that value to jump into the table to find the next instruction. So, if this packet does indeed contain a 1 in this byte, the next instruction is executed, labeled as 2 in FIG. 6. However, if the previous comparison fails, then we jump to the NoMatchCase, which specifies that no filters match this packet.

The second cmpdemux instruction is constructed by looking at the values of the second byte in the current filter set, {f1, f2, f3}. These filters have values 2=0000 0010)₂, and 5=(0000 0101)₂ in this position. These values have the first 5 bits in common, hence cmp_len is set to 5, cmp_val to 0 and demux_len to 3. Now the table contains 8 entries, with the 010 entry representing a match of {f1, f3}, the 101 entry representing a match of {f2}, and all other entries corresponding to no matches to any of the filters. Since the 101 entry only contains f2, and since f2 has a mask length of 2 bytes, processing is done and a leaf of the graph has been reached. In the case of the 010 entry, the {f1, f3} filter set is further subdivided since one of the member filters (f1) contains more bytes to match. In this case, the cmpdemux instruction labeled by 3 is executed.

In the cmpdemux labeled 3, we look at values of the members of the current filter set, {f1, f3}, in byte 3. Since f1 contains 3=(0000011)₂ in this byte and f3 contains a wildcard (0/0), then it is sufficient to set up the cmpdemux to look at the first cmp_len=7 bits of the incoming packet's value in the corresponding byte and see if it contains cmp_val=1. Hence the demux_len is 1. Entry 0 in the table corresponds to matching filter f3.

Since f3 has no remaining byte to compare, processing is done. Entry 1 in the table corresponds to matching filters {f1, f3}. In this case, since there are more bytes to process in f1, the next cmpdemux instruction is executed, labeled as 4. Notice that f3 is a wildcarded filter for byte 3 and was replicated in all table entries for this cmpdemux. In the case that the incoming packet does not match cmp_val=1 for cmp_len=7 bits, the process jumps to the NoMatchCase which corresponds to matching filter f3.

Finally, in the cmpdemux labeled 4, cmp_len is set to 7, cmp_val to 2, and demux_len to 1, similar to step 3. In this case, all table entries represent leaves in the graph and specify final filter match sets.

It should be understood that tree packet filtering methods can be readily implemented in a hardware system, such as a router, to provide a data packet classification apparatus for use in applications such as Differentiated Services. With reference now to FIG. 7, therein is shown a general block diagram for a router capable of use in a data network that allows the implementation of differentiated services by filtering incoming data packets. Specifically, the router 200 includes an interface 210 to data links 230 coupling the router 200 to other parts of the data network 250. Interface 210 provides a point of ingress to incoming data packets. Router 200 is shown to include a processing means in the form of a packet processing unit (PPU) 212 which can be an application specific integrated circuit (ASIC) or general purpose computer processing unit (CPU) adapted to perform the IP packet filtering functions as described herein.

Typically, a set of software instructions in the form of logic 214 is provided to operate in conjunction with ASIC 212 to carry out such functions. Logic means 214 can utilize filters 216 in order to construct a decision tree having a tree-like architecture such as tree-like architectures 50, 100. Of course the specific structure and form of the tree-like architecture would depend on the type of expression matching which is required based on, for example, the level and/or type of service differentiation needed. Therefore, logic means 214, PPU 212, and filters 216 can be used to compare segments (or bytes) of incoming data packets to other values stored in a tree-like hierarchy such that the segments are compared along stages of the tree-like hierarchy and not along every possible edge of a tree-like hierarchy to allow efficient and speedy filtering of incoming data packets. After matching and differentiation, PPU 212 can transmit data packets through egress port 220 which may involve transmission of a data packet to a specified location based on its classification.

The objective of the classification is to determine which of the filters match the current input classification key. As stated above, a classification key is composed of packet fields located at pre-specified offsets within the packet. One skilled in the art can use the methods of the present invention to create a classification key system that tests each byte of the key, in the order determined by the decision tree. The code to perform such a comparison consists of cascaded cmpdemux instructions, each of which narrows down the matching filter list. As discussed above, the cmpdemux instruction looks at the first cmp_len bits of a byte and checks to see if they equal the cmp val quantity. If they match, then take the next demux_len bits and use them as an offset into the demux table, pointed to by the cmpdemux instruction, to obtain the next instruction to execute. If the cmp_len/cmp_val comparison fails, then we jump to the location specified in the Cmp_jail_ptr. The number of cmpdemux instructions that any particular code path will encounter is bounded by the number of bytes in the input key since each cmpdemux divides the filter set according to a particular byte and no further comparison using that byte is necessary.

The code block can contain a simple NoMatch handler, that is, the code that gets executed when a cmpdemux instruction fails. This handler is merely a jump instruction which will jump to the instruction pointed to by the register referred to by the CMP_FAIL macro in the code. Thus, prior to each cmpdemux instruction, the Cmp_fail ptr is loaded with the appropriate NoMatch case address.

One possible example related to the packet filtering problem would occur if a particular set of fields (e.g., source or destination IP address) are possibly distinct in a filter set, but always fully masked (e.g., never containing any wildcard bits). In that case the minimum wildcard heuristic will automatically select a byte from (one of) the non-wildcarded field(s) as the first byte to search. The execution time of the search graph generation across the entire filter set may be avoided (at the possible expense of a minor increase in the size of the total search graph) if the heuristic is disabled for bytes within the non-wildcarded field(s), and the bytes are searched in some fixed order.

If the size of the field is reasonably large (e.g., >=2 bytes), but the set of possible values in the filter set is small relative to the size of the set, then a more compact search method for that field could be employed. For example, a hash of the field could be used as the top-level branch, followed by one or more multi-byte comparisons (the number depending on the hash collision probability). This is an effective way of flattening the height of the search graph by using wider comparisons.

The algorithm described above does not store intermediate results of the number of filters entirely matched, but instead maintains a logical association at each node with the number of feasible filters (those that are not excluded from a match based on the previous comparisons). This approach is not efficient if the filter set has a pathological structure. For example, assume the classification key consists of two elements (e.g., packet header fields). A filter set of N filters consists of N1 filters specifying a value for the first element, and wildcard in the second, while a set of N−N1 filters specifies a value for the second element, and is wildcarded in the first. The set pruning graph algorithm will necessarily generate a graph with N1*(N−N1) leaf nodes, each corresponding to a possible match of one or two filters (each from a different key set). For large numbers of N this can become prohibitive in memory and graph computation time.

This particular problem can be reduced by storing intermediate results. In the example above, since the two sets of filters have disjoint masks, the classification problem could be broken into two independent search operations each on a separate classification key element. Then the results of the two operations could be combined, generating the filter match set.

In a more general case, a filter set may satisfy the property that no individual byte in the set is wildcarded in every filter, but may be wildcarded in a majority of them. The classification problem could be simplified by splitting the filters into disjoint sets, based on the minimum wildcard heuristic, and performing two or more independent search operations. Alternatively, the splitting of the sets could be performed at each level of the graph. This might allow for the search graph of a set of bytes (wildcarded in the previous searches) to be collapsed into a new graph, possibly testing one or more bytes multiple times (trading search graph depth for memory consumption). At the collapse point the set of fully matched filters is saved, and is later concatenated with the next match set. This process can be repeated multiple times as needed, based on the tradeoffs of execution speed and memory needed.

While the invention is described in connection with specific embodiments and with reference to specific diagrams and examples, it should be readily understood that changes and variations in the invention can be devised by those of ordinary skill in the art. For example, while the invention has been described in connection with methods for filtering incoming data packets by searching and comparing against “bytes” of the packets, it should be readily understood that an algorithm or method according to the invention may search and compare based on fields smaller than or larger than a byte. Other variations will be apparent to those of ordinary skill in the art. Therefore, it is contemplated that such changes and variations will be within the spirit of the present invention and captured within the scope of the following claims.

What is claimed is:

1. In a data packet transmission system, a method of filtering an incoming data packet comprising the steps of:
creating a decision graph having a tree-like hierarchy for a set of filters such that the filters are subdivided and grouped along edges and stages of the tree-like hierarchy according to common filter values;
receiving a data packet at a point of ingress to the data packet transmission system; comparing filters along edges of the tree-like hierarchy to portions of the data packet to determine where there are matches; and
if matches are made along an entire edge of the tree-like hierarchy, filtering the data packet stream according to number of condition values compared.

2. The method according to claim 1, wherein said creating step is performed so that the tree-like hierarchy includes wildcards at specified byte values.

3. The method according to claim 2, wherein said creating step is performed by the step of subdividing the set of filters according to common values at specified bytes of said filters.

4. The method according to claim 3, wherein the comparing step further comprises the step of dynamically choosing which byte of a filter to compare against portions of the classification key.

5. The method according to claim 4, further comprising the step of choosing a next byte to compare based on the number of wildcards in a filter.

6. The method according to claim 5, further comprising the step of choosing the byte with the most wildcards.

7. The method according to claim 1, further comprising the step of classifying the data packet according to the number of condition value matches encountered during comparison with the tree-like hierarchy.

8. The method according to claim 1, wherein the condition values are limited by a number of bytes in a filter within the groups of filters.

9. The method according to claim 1, wherein a size of the tree-like hierarchy is minimized based on a specified criteria.

10. The method according to claim 9, wherein the specified criteria is based on a number of irrelevant condition values in the data packet stream.

11. The method according to claim 1, wherein the step of creating a decision tree is performed such that the set of filters are divided into groups of filters based on specific bytes in a search key.

12. The method according to claim 11, wherein the set of filters are divided based on comparing one byte at a time in the search key.

13. The method according to claim 1, wherein the filter conditions are divided into groups of filters based on a maximum number of bits which all filters in the groups of filters have in common.

14. The method according to claim 1, further comprising:
storing intermediate matching values; and matching the stored results with a next byte of the data packet.

15. In connection with a router that receives incoming packets from a data network, a method of filtering the incoming packets at the interface of the router to provide differentiated services, the method comprising the steps of:
constructing a decision tree structure that stores a set of filters in a tree-like hierarchy, the tree-like hierarchy including edges and stages, the set of filters subdivided according to their values along the edges and stages of the tree-like hierarchy;
the interface of the router receiving at least one incoming data packet; and
comparing segments of the incoming data packet to values of the filters stored in the tree-like hierarchy such that the segments are compared along stages and not every edge of the tree-like hierarchy to allow the incoming data packet to be differentiated according to matches between the segments compared and specific filter values.

16. The method of claim 15 wherein said comparison step further comprises the step of executing a single instruction within the PPU that filters the incoming data packet according to its content.

17. The method of claim 16 wherein the step of executing the single instruction further comprises the step of advancing from the beginning of the incoming data packet by a predetermined amount of offset before beginning to compare.

18. The method of claim 15 wherein said comparing step comprises the further steps of:
comparing a first specific byte of the incoming data packet to values of filters in the upper most stage of the tree-like hierarchy,
once a match is made, comparing a second specific byte of the incoming data packet to values of filters contained in a stage below the upper most stage of the tree-like hierarchy and along edges that connect to filters in the upper most stage that match in values to the first specific byte.

19. The method of claim 18 further comprising the step of comparing further bytes of the incoming data packets to values of filters contained in subsequent stages of the treelike structure until a match is made at the lowest stage of the tree-like structure or no match at all.

20. The method of claim 19 wherein said comparing steps further comprise the step of dynamically choosing the next byte of the incoming data packet to compare.

21. The method of claim 19 wherein said comparing steps further comprise the step of replacing specified values in the filters with wildcards.

22. The method of claim 19 wherein said comparing steps further comprise the step of collapsing values in any stage of the tree-like structure so that multiple branches from a parent can lead to the same child.

23. A router for use in a data network and for allowing the implementation of differentiated services by filtering incoming data packets, the router comprising:
an interface to the data network;
a packet processing unit coupled to said interface and adapted for receiving incoming data packets via the interface from the data network;
memory means operably coupled to said packet processing unit and adapted for storing software instructions that cause said packet processing unit to filter incoming data packets; and
a data structure for storing a set of filters in a tree-like hierarchy, the tree-like hierarchy including edges organized into stages, the set of filters subdivided according to their values along the edges and stages of the tree-like hierarchy;
wherein said software instructions are further adapted to cause said packet processing unit to compare segments of incoming data packets to values of the filters stored in the tree-like hierarchy such that the segments are compared along stages and not every edge of the tree-like hierarchy to allow the incoming data packet to be differentiated according to matches between the segments compared and specific filter values.

24. The router of claim 23 wherein said packet processing unit is an application specific integrated circuit or general purpose CPU.

25. The router of claim 24 wherein said application specific integrated circuit is further adapted to filter incoming IP packets based on the contents of the IP packets and using said tree-like structure to provide differentiated services.

26. The router of claim 23 wherein said software instructions comprise a single instruction capable of causing said packet processing unit to filter incoming data packets.

27. The router of claim 23 wherein said software instructions are further adapted to cause said packet processing unit to compare specific bytes of incoming data packets with filter values of said tree-like structure.

28. The router of claim 27 wherein said software instructions are further adapted to cause said packet processing unit to compare a first specific byte of the incoming data packet to values of filters in the upper most stage of the tree-like hierarchy and once a match is made to compare a second specific byte of the incoming data packet to values of filters contained in a stage below the upper most stage of the tree-like hierarchy and along edges that connect to filters in the upper most stage that match in values to the first specific byte.
